(19) United States
(12) Patent Application Publication
(10) Pub. No.: US 2008/0054514 A1
(43) Pub. Date: Mar. 6, 2008

(54) POLYMER FILM PRODUCING METHOD AND APPARATUS

(75) Inventors: Akifumi KATO, Kanagawa (JP); Hidekazu YAMAZAKI, Kanagawa (JP); Hitoshi IKEDA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/851,117

(22) Filed: Sep. 6, 2007

(30) Foreign Application Priority Data
Sep. 6, 2006 (JP) 2006-241273

(51) Int. Cl. B29C 39/20

(52) U.S. Cl. 264/172.19; 264/217; 425/102

(57) ABSTRACT

A polymer film producing apparatus includes a casting device, having a casting die, for ejecting dope to form a bead, and casting the bead on a support drum traveling continuously to form a cast film, the dope containing polymer, solvent and additive. A dryer dries the cast film stripped from the support drum, to obtain a polymer film. A voltage application device is connected with the support drum, for applying voltage to the support drum during casting of the casting device. Preferably, the support drum is electrically non-grounded, and has a surface coated with an electrical insulation film. A surface potential V of the support drum is in a range of 0.1 kV<|V|<3 kV. A decompression chamber is disposed close to a surface of the support drum, for tightening contact of the bead on the surface of the support drum.

### BACKGROUND OF THE INVENTION

1. Field of the Invention

The present invention relates to a polymer film producing method and apparatus. More particularly, the present invention relates to a polymer film producing method and apparatus capable of film production without holes, bubbles or other defects created by air with bead of dope.

2. Description Related to the Prior Art Polymer compounds are used to produce polymer film as optical film owing to advantageous characteristics. The polymer film is attached on a surface of a polarizing element as a constituent of a liquid crystal display panel (LCD). Examples of the optical films are a protection film of a polarizing element, and an optical compensation film (view angle enlarging film or the like), and anti-reflection film. The term of optical film is used to mean the polymer film for use in the field of the optics.

There are two types of known methods of producing the polymer film, including solution casting and melt forming. In the melt forming, polymer pellet is heated and melted, and then extruded by an extruder to form the polymer film. Advantages of the melt forming are the high productivity and simple system for producing the polymer film. However, there are shortcomings of the melt forming in that transparency of the polymer film may decrease due to thermal damage of polymer in the course of heating and melting, and that the control of a thickness of the polymer film with regularity is difficult. Therefore, the solution casting is widely used as a main method of producing the polymer film with high transparency.

In the solution casting, dope containing polymer, solvent and additive is cast on a moving support of casting, to form a cast film. Then the cast film is stripped from the support, and dried to obtain the polymer film. It is important to produce the polymer film with high transparency and high flatness. It has been conceived to improvement of productivity by increasing the casting speed. Thus, the value of the casting speed of the dope is an important factor of consideration. However, problems occur with the increase in the casting speed of the dope. Air may be entrained with bead as a flow of dope from a slot of the casting die to the support. Holes or bubbles may occur in the cast film to lower the flatness upon occurrence of unevenness of surface of the cast film.

Plural ideas have been suggested for preventing entrainment of air. JP-A 2001-113544 discloses the use of an electrode disposed close to a slot of a casting die, for applying voltage between a support belt and bead of the dope in an environment with controlled density of oxygen. U.S. Pat. No. 6,767,500 (corresponding to JP-A 2002-103359) discloses a decompression chamber. A suction orifice is formed in the decompression chamber, and has a plurality of regions split in the width direction of the bead. The space near to the bead is decompressed by adjusting the pressure of each of the regions to control the gas flow.

In the structure of JP-A 2001-113544, an electrode is required in the vicinity of the bead. It is difficult in the course of consecutive operation of the casting to apply voltage, because solvent gas or additives created from the dope deposits on the electrode, or the electrode may deteriorate. The effect of preventing entrainment of air is decreased. In U.S. Pat. No. 6,767,500 (corresponding to JP-A 2002-103359), the decompression chamber is used, but the effect of preventing entrainment of air with the decompression chamber is low. When the casting speed is set higher, edge portions of the bead may be fluctuated and become considerably unstable. The cast film being produced will have low flatness.

### SUMMARY OF THE INVENTION

In view of the foregoing problems, an object of the present invention is to provide a polymer film producing method and apparatus capable of film production without holes, bubbles or other defects created by air with bead of dope.

In order to achieve the above and other objects and advantages of this invention, a polymer film producing method includes a casting step of ejecting dope from a casting die, and casting bead of the dope on a support traveling continuously to form a cast film, the dope containing polymer, solvent and additive. In a drying step, the cast film stripped from the support is dried, to obtain a polymer film. During the casting step, voltage is applied to the support by a voltage application device connected with the support.

The support is electrically non-grounded, and has a surface coated with an electrical insulation film.

The electrical insulation film is formed from a material selected from ceramic material and plastic material, and the material contains at least a selected one of alumina, zirconia, chromium oxide, and titania.

A surface potential V of the support is in a range of 0.1 kV<|V|<3 kV.

In the casting step, the dope is cast in a condition of an oxygen density lower than 10 wt. %.

A tightening device is disposed close to a surface of the support, for tightening contact of the bead on the surface of the support.

The tightening device is a decompression device, disposed close to a slot of the casting die, for decompressing a space upstream from the bead with respect to traveling of the support.

The decompression device sets the space upstream from the bead at a pressure equal to or more than (AP—2,000 Pa) and equal to or less than (AP—10 Pa), where AP is an atmospheric pressure.

The tightening device is an intermediate layer forming device, disposed upstream from the casting die with respect to traveling of the support, for delivery of liquid between the support and the cast film, to form an intermediate layer, the liquid containing at least one solvent contained in the dope.

The electrical insulation film has a multi-layer structure.

In one embodiment, a polymer film producing apparatus includes a casting device, having a casting die, for ejecting dope, and casting bead of the dope on a support traveling continuously to form a cast film, the dope containing polymer, solvent and additive. A dryer dries the cast film stripped from the support, to obtain a polymer film. A voltage application device is connected with the support, for applying voltage to the support during casting of the casting device.

The support is electrically non-grounded, and has a surface coated with an electrical insulation film.

Furthermore, a tightening device is disposed close to a surface of the support, for tightening contact of the bead on the surface of the support.

Accordingly, film production is possible without holes, bubbles or other defects created by air with bead of dope, because of the electrification of the support to tighten contact of the bead on the support.

### BRIEF DESCRIPTION OF THE DRAWINGS

The above objects and advantages of the present invention will become more apparent from the following detailed description when read in connection with the accompanying drawings, in which:

FIG. 1 is an explanatory view in elevation, illustrating a polymer film producing apparatus;

FIG. 2 is an explanatory view in elevation, illustrating a casting device in the polymer film producing apparatus;

FIG. 2A is a section, partially broken, illustrating a cast film, an intermediate layer and the casting device.

### DETAILED DESCRIPTION OF THE PREFERRED EMBODIMENT(S)OF THE PRESENT INVENTION

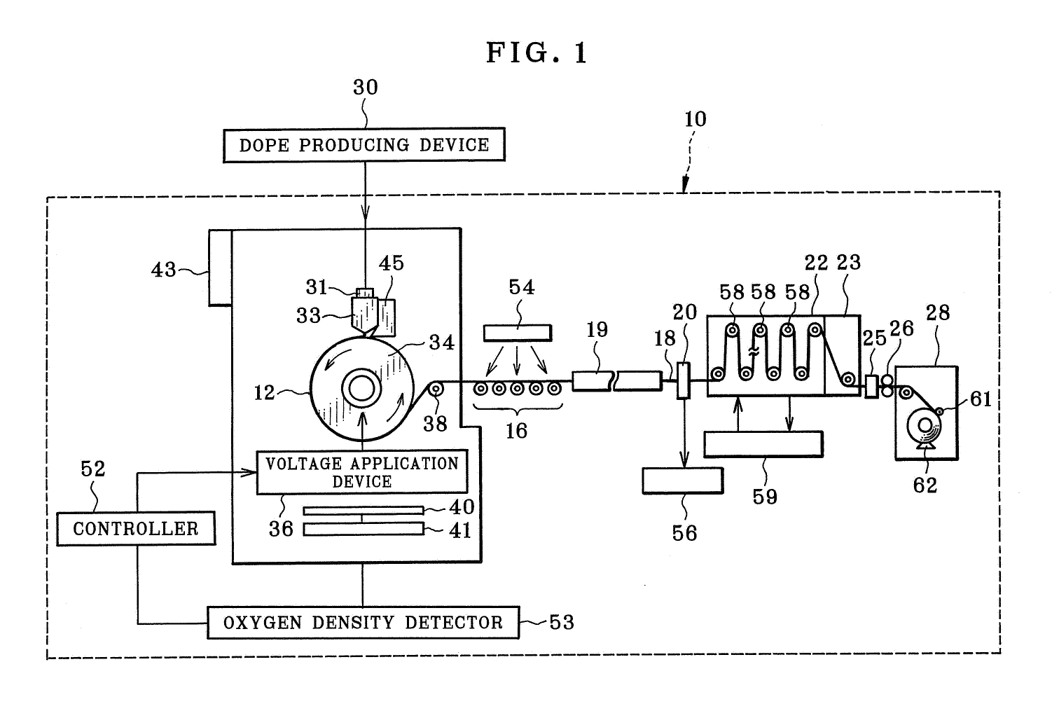

In FIG. 1, a polymer film producing apparatus or system 10 is illustrated, which is for use in the polymer film production of the invention.

The polymer film producing apparatus 10 includes a casting chamber 14 as casting device, a transition region 16, a tentering machine 19, a web edge slitter 20, a drying chamber or dryer 22, a cooling chamber or cooler 23, a static eliminator 25, a knurling roller 26 and a winder 28. The casting chamber 14 casts dope on to a support moving continuously, so that cast film 12 is formed. The transition region 16 promotes drying of the cast film 12 stripped from the support. The tentering machine 19 promotes drying of the cast film 12 transported by holding web edges of the cast film 12 on tenter clips, and obtains a polymer film 18. The web edge slitter 20 slits web edges of the polymer film 18. The drying chamber 22 dries the polymer film 18 in a sufficient manner. The cooling chamber 23 cools the polymer film 18 after drying. The static eliminator 25 to eliminate charge adjusts the voltage of electrifying the polymer film 18. The knurling roller 26 knurls the polymer film 18. The winder 28 winds the polymer film 18 in a roll form. A dope producing device 30 is connected with the polymer film producing apparatus 10 by a conduit of dope, and supplies the polymer film producing apparatus 10 with the dope at a suitable amount.

The casting chamber 14 includes a feed block 31, a casting die 33 as casting device, a casting support drum 34, a stripping roller 38, a condenser 40, and a solvent recovery device 41. The feed block 31 supplies dope from the dope producing device 30. The casting die 33 has a slot, and ejects the dope onto the support. The support drum 34 is a support for casting. The stripping roller 38 supports the cast film 12 for the purpose of stripping the cast film 12 from the support drum 34. The condenser 40 condenses solvent gas in the casting chamber 14. The solvent recovery device 41 recovers the liquefied solvent by withdrawal. A heat exchange medium circulator (not shown) is connected with the support drum 34, and supplies a flow conduit in the support drum 34 with heat exchange medium conditioned at a suitable temperature, to adjust the surface temperature of the support drum 34. A temperature adjuster 43 is disposed outside the casting chamber 14, and adjusts the inner temperature of the casting chamber 14.

A flow conduit is formed in the feed block 31 for dope. The form of the flow conduit can be modified to adjust the structure of the cast film 12. A decompression chamber 45 or decompression device as a tightening device is associated with the casting die 33. A rear side or upstream side of the bead of the dope is decompressed by the decompression chamber 45, the bead flowing from the ejection slot down to the support drum 34. A jacket (not shown) is associated with the decompression chamber 45 for adjusting the inner temperature by a flow of heat exchange medium controlled in the temperature. This is for the purpose of preventing gaseous solvent from deposition on the surface of the decompression chamber 45 even in evaporation from the dope or the cast film 12.

The shape, material, size and the like of the casting die 33 are not limited. A coat hanger type of die is preferable for the casting die 33 so a casting width of the dope can be kept at a predetermined size. A preferable size of the slot is 1.1-2.0 times as long as the casting width of the dope. A preferable material of the casting die 33 can be stainless steel of a type of precipitation hardening owing to the durability, heat resistance and the like. Also, the material of the casting die 33 has the corrosion resistance sufficient for prevention of pitting on the gas-liquid interface even after dipping in a liquid mixture of dichloromethane, methanol and water for three (3) months. Desirably, a corrosion resistance of the material should be equal to that of SUS 316 steel according to forced corrosion test in electrolytic aqueous solution. In view of heat resistance, the material can have a coefficient of thermal expansion of 2×10⁻⁵ (/deg. C.) or less. A hardened layer or case can be preferably formed on the end of the lip of the casting die 33. Various methods for forming the hardened layer or case can be used, including application of a ceramic coating, a hard chromium plating, and processing of nitriding. In case of using the ceramic coating, the material of the ceramic coating should have suitability for grinding, low porosity, low fragility, high resistance to corrosion, suitability for adhesion to the casting die 33, and property free from adhesion to the dope. Specifically, WC (tungsten carbide), Al₂O₃, TiN, Cr₂O₃ and the like can be used, among which WC is particularly preferable. A thermal spray process can be used for applying a WC coating.

A contact surface of the casting die 33 for the dope is preferably a polished or abraded surface for high smoothness to form the cast film 12 with high flatness. An absorption device (not shown) is preferably connected to a slot edge portion of the casting die 33, and absorbs air at an edge flow rate of 1-100 liters per minute. Thus, it is possible to reduce an air flow which might cause unevenness on surfaces of the bead.

The support drum 34 rotates continuously. A support for casting may not be the support drum 34. For example, a casting support belt may be used, which is supported on a pair of rollers for turning about in an endless manner. A width of the support drum 34 may not be limited to a certain size. A preferable width of the support drum 34 can be 1.1-2.0 times as much as a casting width of the dope. The material of the support drum 34 is preferably stainless steel, and has sufficient strength and resistance to corrosion. The surface of the support drum 34 should be preferably polished for the purpose of forming a cast film with high flatness. A drive mechanism (not shown) drives the support drum 34 of a stainless steel to rotate continuously during casting of the dope.

A voltage application device 36 as charge applicator is connected with the support drum 34. A high voltage of a direct current is applied to the support drum 34 by the voltage application device 36, to generate an electric field of the support drum 34. A controller 52 controls the start and stop of powering of the voltage application device 36. Also, the support drum 34 is non-grounded electrically. Thus, the support drum 34 is kept electrified.

The transition region 16 has plural transport rollers and a fan or blower 54 for drying. The transport rollers support the cast film 12. The fan or blower 54 blows dry gas to the cast film 12. The tentering machine 19 includes a pair of tenter chains (not shown) and a temperature adjuster (not shown). The tenter chains have pin plates, in which a plurality of pins hold web edges of the cast film 12 in a firm manner. The temperature adjuster adjusts an inner temperature of the tentering machine 19. A pair of rails are disposed in the tentering machine 19 to extend with an increasing interval from the upstream end toward the downstream end of the tentering machine 19. The tenter chains are supported on the rails, and travel inside the tentering machine 19 along the rails.

A film crusher 56 is connected with the web edge slitter 20 for crushing cut portions of web edges of the polymer film 18 as chips. Plural rollers 58 and a temperature adjuster (not shown) are contained in the drying chamber 22. The rollers 58 transport the polymer film 18 by contact. The temperature adjuster adjusts the inner temperature. An adsorption solvent recovery device 59 is disposed outside the drying chamber 22, and recovers solvent gas evaporated from the polymer film 18 according to adsorption. A press roller 61 and a winding roller 62 are disposed in the winder 28. The press roller 61 applies pressure to the polymer film 18.

A process of producing the polymer film 18 from the polymer film producing apparatus 10 is described. A dope is prepared by the dope producing device 30, and is caused flow through the feed block 31 to the casting die 33.

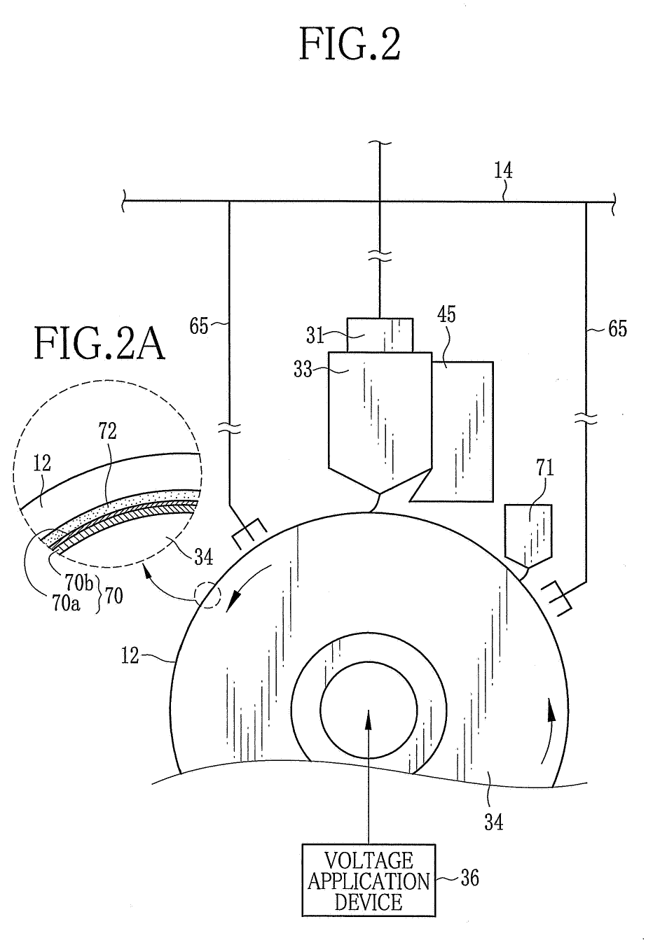

In FIG. 2, a region where the dope is cast is illustrated. A labyrinth seal 65 splits the inside of the casting chamber 14 to keep inside the region with the casting die 33 having the ejection slot and the decompression chamber 45 or decompression device. This is to reduce influence of air flow caused by rotation of the support drum 34 in the casting chamber 14 to change the surface quality of the bead.

The voltage application device 36 applies high voltage to the support drum 34 with a direct current. The potential V of the surface of the support drum 34 is set in a range of 0.1 kV<|V|<3 kV by adjusting the power of the voltage application device 36. When the dope is ejected by the casting die 33 toward the support drum 34, the bead is attracted to the support drum 34. Thus, entrainment of air is suppressed by tightening the contact between the bead and the support drum 34. Should the voltage V be lower than 0.1 kV, entrainment of air is difficult to suppress, because only small force is exerted between the bead and the support drum 34. Should the voltage V be higher than 3 kV, unevenness occurs on the surface because the bead is attracted on to the support drum 34 with excessive force.

In FIG. 2A, an electrical insulation film 70 is formed as an outer layer of the support drum 34. Since the electrical insulation film 70 is formed on the peripheral surface of the support drum 34 on which the bead is cast, and the discharge treatment described above is applied thereto, it is possible to form a discharge path dendritically expanded along the surface of the electrical insulation film 70 and charge the support drum 34 made of stainless readily. Although the above insulating substance is not especially limited, there are: ceramic containing at least one of alumina, zirconia, chromium oxide, and titania, or containing a mixture having at least two of alumina, zirconia, chromium oxide, and titania; polytetrafluoroethylene (PTFE); and plastic, for example. The method of coating, the layer thickness and the like are not limited. It is preferable to form the electrical insulation film 70 with a regular thickness on the entire surface of the support drum 34. In the present embodiment, the electrical insulation film 70 is a ceramic material containing alumina as a component, and formed by melting and adhesion.

Preferably, the electrical insulation film 70 has a multi, layer structure rather than a single-layer structure. The multi-layer structure includes a first layer 70a in contact with the cast film 12 and a second layer 70b formed on the first layer 70a. The second layer 70b is thicker than the first layer 70a. In order to make the surface of the cast film 12 in contact with the first layer 70a smooth as much as possible, the exposed surface of the first layer 70a is preferably smooth. When the surface of the cast film 12 is rough, in many cases, the surface of the polymer film 18 (see FIG. 1) is also rough. In order to make the exposed surface of the first layer 70a made of ceramics smooth, the diameter of particles of ceramics as the material is preferably small. The same holds true for PTFE instead of ceramics as the material of the first layer 70a.

In a case where the diameter of particles of ceramics or PTFE for use in the first layer 70a is made shorter, the first layer 70a is more easily broken or tends to take on cracks. The tendency described above becomes more remarkable as the thickness of the first layer 70a becomes thicker for the purpose of imparting electrical insulating properties to the peripheral surface of the support drum 34. In view of the above, the second layer 70b is formed on the first layer 70a. Namely, the second layer 70b is a layer around a body of the support drum 34, and not exposed to the outside. The diameter of the particles of ceramics of PTFE in the second layer 70b is made larger than that in the first layer 70a. Thereby, the electrical insulation film 70 has smoothness and no cracks, and is not easily broken by a long-term use. Further, since the electrical insulation film 70 has a multi-layer structure including the first and second layers 70a and 70b, made from the materials as described above, the exposed surface can be smooth, and the electrical insulating properties can be strong. Note that plural second layers 70b may be formed so as to be stacked on one another.

While the cast film 12 is formed, an oxygen density detector 53 is used to measure oxygen density in the casting chamber 14. A flow of nitrogen gas is controlled to set the oxygen density in the casting chamber 14 lower than 10 wt. % according to the measured density. This is effective in minimizing occurrence of explosion, fire and other danger in the casting chamber 14. The oxygen density can be adjusted easily by supplying gas of a suitable one of examples in the casting chamber 14, the examples including nitrogen gas, carbon dioxide gas, and other inert gases, and mixture of air with inert gas. Should the oxygen density be equal to or more than 10 wt. %, an alarm signal is generated. Data of the measured density is sent to the controller 52 which stops driving the voltage application device 36.

In the course of casting, the decompression chamber 45 conditions the pressure in such a manner that the pressure on the rear side of the bead is lower than the atmospheric pressure. The bead is sucked in a direction toward the support drum 34. Entrainment of air on the bead is suppressed. Also, an air flow near to the bead is reduced to suppress fluctuation of the surface while the bead is cast. As the region of the casting is surrounded by the labyrinth seal 65, pressure in the vicinity of the bead can be lowered by the decompression chamber 45 efficiently. It is preferable that the pressure of the rear side of the bead is equal to more than (AP—2,000 Pa) and equal to or less than (AP—10 Pa) where AP is the atmospheric pressure.

An intermediate layer forming device 71 as a tightening device is disposed on the upstream side from the casting die 33 with respect to the drum rotating direction. The intermediate layer forming device 71 supplies the support drum 34 with liquid of a predetermined type before forming the cast film 12, so that an intermediate layer 72 of FIG. 2A is formed by the intermediate layer forming device 71 on the support drum 34. A preferable example of the liquid of the predetermined type is one of plural types of solvents contained in the dope. As the bead is cast on the support drum 34 together with the intermediate layer 72, the cast film 12 can be formed in preventing entrainment of air. Excessively tight contact between the support drum 34 and the cast film 12 is prevented as the tightness of the contact is controlled indirectly. It is possible in a posterior step to strip the cast film 12 from the support drum 34 easily by applying small stress of stripping. Note that the intermediate layer 72 scatters with time on the cast film 12. An interface between the cast film 12 and the intermediate layer 72 can be free from dissociation because of high compatibility.

A surface temperature of the support drum 34 is constantly in a range of −40 to 30 deg. C. In the embodiment, the surface temperature of the support drum 34 is maintained at −10 deg. C. by a flow of the heat exchange medium conditioned by the heat exchange medium circulator and supply in the flow path formed inside the support drum 34. In the casting, temperature of the dope is constantly in a range of −10 to 55 deg. C. In the embodiment, temperature of the dope is maintained at −5 deg. C., which can be set easily by adjusting the inner temperature of the feed block 31 and the casting die 33. Therefore, the bead is cooled on the support drum 34 efficiently and effectively. The cast film 12 of a gel form can be obtained only in a short time.

The degree of the adhesion between the cast film 12 and the support drum 34 can be adjusted by forming the intermediate layer 72. It is preferable for the intermediate layer 72 to satisfy the condition of t<−0.05w+15, where w (t) is a ratio of the good solvent in the solution for the intermediate layer 72, and t (microns) is a thickness of the intermediate layer 72. Thus, it is possible to form the intermediate layer 72 facilitating stripping of the cast film 12 from the support drum 34. Should the thickness of the intermediate layer 72 be too great, diffusion of the intermediate layer 72 on the cast film 12 does not occur easily. Residue of the intermediate layer 72 may remain on the support drum 34. The residue of the intermediate layer 72 on the support drum 34 will influence to succeeding operation of casting and lower the surface quality of the polymer film. Note that the position of the intermediate layer forming device 71 is not limited. For example, the intermediate layer forming device 71 can be disposed near to the casting die 33 so as to supply liquid along the rear side of the bead.

As a tightening device for tightness between the cast film 12 and the support drum 34, an air knife may be used in combination with or in addition to the intermediate layer forming device 71. It is preferable with the air knife to blow air to the cast film 12 extending from the bead in the downstream direction of the rotation of the support drum 34. The tightness of the contact between the cast film 12 and the surface of the support drum 34 can be suitably adjusted by adjusting the air of the air knife for its speed, flow rate and the like.

Specifically, a solvent delivery device (not shown) can be connected to an end of the die slot of the casting die 31. A solvent for imparting solubility to the dope can be supplied to a gas-liquid-solid interface between an end of the casting bead, the die slot, and ambient gas. An example of the solvent can be a mixed solvent containing 86.5 parts by weight of dichloromethane, 13 parts by weight of methanol, and 0.5 part by weight of n-butanol. It is possible to prevent drying and local solidification of dope at the end of the die slot to stabilize the bead. The polymer film 18 with high transparency without defects can be obtained because of reduction of unwanted mixture of solidified dope in the bead or the cast film 12 as foreign material. A pump for delivering the mixed solvent should have a fluctuation ratio of 5% or lower. The mixed solvent should be delivered to each of two slot ends at a range of 0.1-1.0 ml/min for the purpose of preventing existence of foreign materials in the cast film.

Solvent gas contained in the casting chamber 14 is condensed and liquefied by the condenser 40, and then recovered by the solvent recovery device 41. Thus, the solvent gas in the casting chamber 14 can be reduced effectively. The recovered solvent is refined by a refiner (not shown), and is reused as a dope preparing solvent. Therefore, the cost for the material can be reduced. Note that the inner temperature of the casting chamber 14 can be regulated constantly in a range of −10 to 57 deg. C. by the temperature adjuster 43.

Gelling of the cast film 12 proceeds by cooling on the support drum 34 in lapse of time. When the cast film 12 comes to have a self-supporting property in the course of gelling, the cast film 12 is stripped from the support drum 34 while supported by the stripping roller 38. The cast film 12 immediately after stripping can preferably have a residual solvent amount of the solvent in a range of 10-200 wt. %. The residual solvent amount is an amount of the main solvent in any one of the cast film, polymer film or other sample. If solvent in the sample is a composition containing plural examples or compounds, one of those having the largest amount of them is regarded as the main solvent. The residual solvent amount is an amount expressed in the formula of [(x−y)/y]0.100 where x is a weight of the inspected sample according to the dry base, and y is a weight of the sample in the totally dried state.

Then the cast film 12 is transported through the transition region 16 having a plurality of rollers, and moved to the tentering machine 19. In the transition region 16, the fan or blower 54 blows, dry gas at an intended temperature, to quicken drying of the cast film 12. It is preferable that the temperature of the dry gas is 20-250 deg. C., so the cast film 12 be dried efficiently without damage of heat. It is also possible in the transition region 16 to rotate one or more specific rollers faster than rollers that are upstream from the specific rollers, for the purpose of stretching the cast film 12 with tension in the casting direction. The cast film 12 can be transported without occurrence of wrinkles, streak or other surface defects.

The cast film 12 is transported into the tentering machine 19, where plural pins near to the upstream end of the tentering machine 19 are pierced in web edges of the cast film 12 for fixation. A temperature adjuster (not shown) is associated with the tentering machine 19, and adjusts the temperature. Rails are disposed to extend with their increasing interval in the downstream direction within the tentering machine 19. The cast film 12 becomes gradually stretched in the web width direction while transported. Molecular orientation of the cast film 12 is controlled in the web width direction. The polymer film 18 with high retardation is obtained after promoting drying of the cast film 12. Note that a device for compression may be used for stretching the cast film 12 in the web width direction in place of the use of the rails for stretching and orientation. In the downstream end of the tentering machine 19, the pins are released from the polymer film 18 which becomes free from the fixation. Note that the tenter pins are used in the tentering machine 19. However, the tentering machine 19 may be a clip type in which tenter clips are used for holding the web edges of the cast film 12.

The web edge slitter 20 slits away the web edge portions of the polymer film 18 transported out of the tentering machine 19. Pierced regions in the web edge portions due to the tenter pins for the polymer film 18 are eliminated by cutting. Note that no slitting of the polymer film 18 can be performed in the producing system. However, it is preferable to slit the polymer film 18 in any of plural regions from the cast film 12 to the winder 28, for the purpose of the polymer film 18 without much defects.

The polymer film 18 is transported into the drying chamber 22 and supported and moved by the rollers 58. A temperature adjuster (not shown) is used to control the surface temperature of the polymer film 18 in a constant range of 60-145 deg. C. Thus, drying of the polymer film 18 can be promoted without thermal damage. A thermometer (not shown) is disposed on a transport path of the polymer film 18 and close to its surface, so the surface temperature of the polymer film 18 can be found easily. Gaseous solvent evaporated from the polymer film 18 is recovered by the adsorption solvent recovery device 59 in the drying chamber 22. Then the solvent component is removed from air, which is caused to flow in the drying chamber 22 as dry air. Thus, no gaseous solvent remains on the polymer film 18. A cost for energy can be reduced.

The polymer film 18 is transported to the cooling chamber 23, and cooled down approximately to the room temperature. Any of various cooling methods can be used. For example, the polymer film 18 can be left to stand for natural cooling in the cooling chamber 23 set at the room temperature for heat dissipation. Furthermore, a fluidity adjusting chamber (not shown) may be disposed between the drying chamber 22 and the cooling chamber 23. The polymer film 18 can be cooled after adjustment of fluidity of the polymer film 18 in the chamber. This is effective in flattening the polymer film 18 even when wrinkles have occurred on the surface of the polymer film 18.

The static eliminator 25 adjusts the voltage of the polymer film 18 in the electrification in the condition of the room temperature. A preferable range of the electrification of the polymer film 18 is not limited, but should be constant, and preferably can be in a range from −3 kV to +3 kV. Furthermore, the knurling roller 26 is used to knurl web edge portions of the polymer film 18 by embossing. Finally, the polymer film 18 is transported to the winder 28. The press roller 61 adjusts tension applied to the polymer film 18 in the course of the winding. The winding roller 62 winds the polymer film 18. The tension in winding the polymer film 18 should be preferably changed gradually from the start to the end of the winding. This is effective in safely winding without occurrence of wrinkles, streaks or other defects.

According to the above, the polymer film 18 with high flatness can be produced rapidly and stably. A web length of the polymer film 18 can be equal to or more than 100 meters in the casting direction. The polymer film 18 can have a width equal to or more than 1,400 mm and equal to or less than 1,800 mm. The feature of the invention is effective also if the width is over 1,800 mm. The thickness of the polymer film 18 as a final product is not limited, but is equal to or more than 20 microns and equal to or less than 500 microns. The thickness of the polymer film 18 is preferably equal to or more than 30 microns and equal to or less than 300 microns, and desirably equal to or more than 35 microns and equal to or less than 200 microns. The thickness of the polymer film may be very small according to the invention, for example a thickness equal to or more than 15 microns and equal to or less than 100 microns.

In the above embodiment, a single dope is cast to form a polymer film of a single layer. In the solution casting of the invention, the dopes, namely two or more dopes, can be cast according to simultaneous multi casting or successive multi casting. For the simultaneous multi casting, it is possible to use any one of a casting die with a feed block, and a multi-manifold casting die. Various methods suggested in JP-A 2005-104148 are usable in combination to the casting of the invention, the methods including construction of the casting die, decompression chamber, support and other mechanical elements, multi casting, stripping, stretching, conditioning for drying in respective steps, polymer film handling, winding after eliminating a curl for flatness, solvent collection, and polymer film collection. Those can be used in the present invention. Curls, thickness and their measurement of the wound polymer film are suggested in known documents mentioned in JP-A 2005-104148. These can be used in the present invention.

A. Support of Metal for Solution Casting

Suggested in JP A 2000-84960; U.S. Pat. No. 2,336,310, U.S. Pat. No. 2,367,603, U.S. Pat. No. 2,492,078, U.S. Pat. No. 2,492,977, U.S. Pat. No. 2,492,978, U.S. Pat. No. 2,607,704, U.S. Pat. No. 2,739,069, U.S. Pat. No. 2,739,070, GB A 640731 (corresponding to U.S. Pat. No. 2,492,977), GB A 735892; JP B 45-4554, JP B 49-5614, JP A 60-176834, JP A 60-203430, and JP A 62-115035.

B. Multi Casting

Suggested in JP B 62-43846; JP A 61-158414, JP A 1-122419, JP B 609-27562, JP A 61-94724, JP A 61-947245, JP A 61-104813, JP A 61-158413, JP A 6-134933; JP A 56-162617; JP A 61-94724, JP A 61-94725, and JP A 11-198285.

C. Specific Methods of Casting of Cellulose Esters

Suggested in JP A 61-94724, JP A 61-148013, JP A 4-85011 (corresponding to U.S. Pat. No. 5,188,788), JP A 4-286611, JP A 5-185443, JP A 5-185445, JP A 6-278149, and JP A 8-207210.

D. Stretching

Suggested in JP A 62-115035, JP A 4-152125, JP A 4-284211, JP A 4-298310, and JP A 11-48271.

E. Specific Methods of Drying

Suggested in JP A 8-134336, JP A 8-259706, and JP A 8-325388.

F. Drying of specific controls of heat Suggested in JP A 04-001009 (corresponding to U.S. Pat. No. 5,152,947), JP A 62-046626, JP A 04-286611, and JP A 2000-002809.

G. Drying in Preventing Wrinkles

Suggested in JP A 11-123732, JP A 11-138568, and JP A 2000-176950.

At least one of the two surfaces of the polymer film is preferably processed by surface processing so as to ensure adhesion with a polarization plate or other optics. Examples of the surface processing include vacuum glow discharge processing, atmospheric pressure plasma discharge processing, ultraviolet radiation applying processing, corona discharge processing, flame processing, acid processing, alkali processing and the like.

The obtained cast film as a final product can preferably be coated with a functional material, to form a functional film including the polymer film as base, and one or two functional layers overlaid on the base. Examples of functional layers include an antistatic layer, a hard resin layer, anti reflection layer, attachment facilitating layer, anti-glare layer, optical compensation layer and the like. For example, forming of the anti reflection layer can result in obtaining anti reflection film of which high image quality is available by preventing reflection of outer light. Methods of adding the surface processed functional layers to the cellulose ester film, and their various conditions are according to techniques suggested in JP-A 2005-104148. Those can be used in the present invention.

I. Plasma Processing in General

Suggested in JP A 6-123062 (corresponding to EP A 592979), JP A 11-5857, and JP A 11-293011.

II. Specific Methods of Plasma Processing

Suggested in JP A 2003-161807, JP A 2003-166063 (corresponding to U.S. Pat. No. 6,849,306), JP A 2003-171770, JP A 2003-183836, JP A 2003-201568, and JP A 2003-201570.

III. Glow Discharge Processing

Suggested in U.S. Pat. No. 3,462,335, U.S. Pat. No. 3,761,299, U.S. Pat. No. 4,072,769, GB A 891469; JP A 59-056430, and JP B 60-16614 (corresponding to GB A 1579002).

IV. Ultraviolet Processing

Suggested in JP B 43-2603, JP B 43-2604, and JP B 45-3828 (corresponding to GB A 1149812).

V. Corona Discharge Processing

Suggested in JP B 39-12838, JP A 47-19824 (corresponding to U.S. Pat. No. 3,849,166), JP A 48-28067 (corresponding to U.S. Pat. No. 3,755,683), and JP A 52-42114 (corresponding to U.S. Pat. No. 4,135,932).

VI. Matte Agents for Undercoats

Suggested in U.S. Pat. No. 4,142,894, and U.S. Pat. No. 4,396,706.

VII. Lubricants

Suggested in JP B 53-292, U.S. Pat. No. 3,933,516, U.S. Pat. No. 4,275,146; JP B 58-33541, GB A 927446 (corresponding to U.S. Pat. No. 3,121,060); JP A 55-126238, JP A 58-90633; JP A 58-50534; and European Patent Application 90108115 (corresponding to U.S. Pat. No. 5,063,147).

VIII. Polyorganosiloxanes as Lubricants

Suggested in JP B 53-292, JP B 55-49294, and JP A 60-140341.

IX. Antistatic Agents of Ionic Macromolecular Types

Suggested in JP B 49-23827, JP B 49-23828, JP B 47-28937; JP B 55-734, JP A 50-54672, JP B 59-14735, JP B 57-18175, JP B 57-18176, JP B 57-56059; JP B 53-13223, JP B 57-15376, JP B 53-45231, JP B 55-145783, JP B 55-65950, JP B 55-67746, JP B 57-11342, JP B 57-19735, JP B 58-56858, JP A 61-27853, and JP B 62-9346.

X. Polymer Films Coatable with Hard Coat Layers

Suggested in JP A 6-123806, JP A 9-113728, and JP A 9-203810.

XI. Photo Polymerizable Compounds

Suggested in JP A 50-151996, JP A 50-158680; JP A 50-151997 (corresponding to U.S. Pat. No. 4,058,401), JP A 52-30899 (corresponding to U.S. Pat. No. 4,256,828), JP A 55-125105; JP A 56-8428 (corresponding to U.S. Pat. No. 4,299,938), JP A 56-55420 (corresponding to U.S. Pat. No. 4,374,066), JP A 56-149402 (corresponding to U.S. Pat. No. 4,339,567), JP A 57-192429 (corresponding to U.S. Pat. No. 4,387,216); JP B 49-17040; and U.S. Pat. No. 4,139,655.

XII. Coatings for Preventing Reflection

Suggested in JP A 7-126552, JP A 7-188582, JP A 8-48935, JP A 8-100136, JP A 9-220791, and JP A 9-272169.

Various examples of liquid crystal display panels are known and suggested in JP-A 2005-104148, including TN type, STN type, VA type, OCB type, reflection type and the like. Any of those can be used in the present invention.

No. 1. Cellulose Ester Protective Films for Polarizers

Suggested in JP A 10-095861, JP A 10-095862, and JP A 09-113727.

No. 2. Uses of Cellulose Ester Films as High Performance Optical Elements Suggested in JP A 2000-284124, JP A 2000-284123, and JP A 11-254466.

No. 3. Production of Cellulose Ester Films as High Performance Optical Elements

Suggested in JP A 2000-131523, JP A 06-130226, JP A 06-235819, JP A 2000-212298 (corresponding to U.S. Pat. No. 6,731,357), and JP A 2000-204173.

No. 4. Optical Compensation Sheets

Suggested in JP A 3-9325 (corresponding to U.S. Pat. No. 5,132,147), JP A 6-148429, JP A 8-50206 (corresponding to U.S. Pat. No. 5,583,679), and JP A 9-26572 (corresponding to U.S. Pat. No. 5,855,971).

No. 5. TN Type of LCD Panels

Suggested in JP A 3-9325 (corresponding to U.S. Pat. No. 5,132,147), JP A 6-148429, JP A 8-50206 (corresponding to U.S. Pat. No. 5,583,679), and JP A 9-26572 (corresponding to U.S. Pat. No. 5,855,971).

No. 6. Reflection Type of LCD Panels

Suggested in JP A 10-123478, WO 9848320 (corresponding to U.S. Pat. No. 6,791,640), JP B 3022477 (corresponding to U.S. Pat. No. 6,433,845); and WO 00-65384 (corresponding to EP A 1182470).

No. 7. Discotic Compounds as Coating Cellulose Ester Films

Suggested in JP A 7-267902, JP A 7-281028 (corresponding to U.S. Pat. No. 5,518,783), and JP A 7-306317.

No. 8. Characteristics of Optical Compensation Sheets

Suggested in JP A 8-5837, JP A 7-191217, JP A 8-50206, and JP A 7-281028.

No. 9. Production of Optical Compensation Sheets

Suggested in JP A 9-73081, JP A 8-160431, and JP A 9-73016.

No. 10. Use of Cellulose Ester Films in LCD Panels

Suggested in JP A 8-95034, JP A 9-197397, and JP A 11-316378.

No. 11. LCD Elements of Guest-Host Reflection Types

Suggested in JP A 6-222350, JP A 8-36174, JP A 10-268300, JP A 10-292175, JP A 10-293301, JP A 10-311976, JP A 10-319442, JP A 10-325953, JP A 10-333138, and JP A 11-38410.

No. 12. Coating Methods

Suggested in U.S. Pat. No. 2,681,294; U.S. Pat. No. 2,761,791, U.S. Pat. No. 2,941,898, U.S. Pat. No. 3,508,947, and U.S. Pat. No. 3,526,528.

No. 13. Constructions of Overlaying Coatings

Suggested in JP A 8-122504, JP A 8-110401, JP A 10-300902 (corresponding to U.S. Pat. No. 6,207,263), JP A 2000-111706; JP A 10-206603 (corresponding to U.S. Pat. No. 6,207,263), and JP A 2002-243906.

No. 14. High Refractive Index Layer and Middle Refractive Index Layer

Suggested in JP A 11-295503, JP A 11-153703, JP A 2000-9908; JP A 2001-310432; JP A 2001-166104; JP A 11-153703, U.S. Pat. No. 6,210,858, JP A 2002-2776069; JP A 2000-47004, JP A 2001-315242, JP A 2001-31871, JP A 2001-296401; and JP A 2001-293818.

No. 15. Low Refractive Index Layer

Suggested in JP A 9-222503; JP A 11-38202; JP A 2001-40284; JP A 2000-284102; JP A 11-258403; JP A 58-142958, JP A 58-147483, JP A 58-147484, JP A 9-157582, JP A 11-106704; JP A 2000-117902, JP A 2001-48590, and JP A 2002-53804.

No. 16. Hard Coat Layer Suggested in JP A 2002-144913, JP A 2000-9908, and WO 00/46617 (corresponding to U.S. Pat. No. 7,063,872).

No. 17. Front Scattering Layer

Suggested in JP A 11-38208, JP A 2000-199809, and JP A 2002-107512.

No. 18. Antiglare Characteristic

Suggested in Japanese Patent Application 2000-271878 (corresponding to JP A 2002-082207); JP A 2001-281410, Japanese Patent Application 2000-95893 (corresponding to U.S. Pat. No. 6,778,240), JP A 2001-100004 (corresponding to U.S. Pat. No. 6,693,746), JP A 2001-281407; JP A 63-278839, JP A 11-183710, and JP A 2000-275401.

No. 19. Dichroic Compounds

Suggested in JP A 1-161202, JP A 1-172906, JP A 1-172907, JP A 1-183602, JP A 1-248105, JP A 1-265205, and JP A 7-261024 (corresponding to U.S. Pat. No. 5,706,131).

No. 20. Various Devices and Films for Optics

Suggested in JP A 5-19115, JP A 5-119216, JP A 5-162261, JP A 5-182518, JP A 5-196819, JP A 5-264811, JP A 5-281411, JP A 5-281417, JP A 5-281537, JP A 5-288921, JP A 5-288923, JP A 5-311119, JP A 5-339395, JP A 5-40204, JP A 5-45512, JP A 6-109922, JP A 6-123805, JP A 6-160626, JP A 6-214107, JP A 6-214108, JP A 6-214109, JP A 6-222209, JP A 6-222353, JP A 6-234175, JP A 6-235810, JP A 6-241397, JP A 6-258520, JP A 6-264030, JP A 6-305270, JP A 6-331826, JP A 6-347641, JP A 6-75110, JP A 6-75111, JP A 6-82779, JP A 6-93133, JP A 7-104126, JP A 7-134212, JP A 7-181322, JP A 7-188383, JP A 7-230086, JP A 7-290652, JP A 7-294903, JP A 7-294904, JP A 7-294905, JP A 7-325219, JP A 7-56014, JP A 7-56017, JP A 7-92321, JP A 8-122525, JP A 8-146220, JP A 8-171016, JP A 8-188661, JP A 8-21999, JP A 8-240712, JP A 8-25575, JP A 8-286179, JP A 8-292322, JP A 8-297211, JP A 8-304624, JP A 8-313881, JP A 8-43812, JP A 8-62419, JP A 8-62422, JP A 8-76112, JP A 8-94834, JP A 9-137143, JP A 9-197127, JP A 9-251110, JP A 9-258023, JP A 9-269413, JP A 9-269414, JP A 9-281483, JP A 9-288212, JP A 9-288213, JP A 9-292525, JP A 9-292526, JP A 9-294959, JP A 9-318817, JP A 9-80233, JP A 9-99515, JP A 10-10320, JP A 10-104428, JP A 10-111403, JP A 10-111507, JP A 10-123302, JP A 10-123322, JP A 10-123323, JP A 10-176118, JP A 10-186133, JP A 10-264322, JP A 10-268133, JP A 10-268134, JP A 10-319408, JP A 10-332933, JP A 10-39137, JP A 10-39140, JP A 10-68821, JP A 10-68824, JP A 10-90517, JP A 11-116903, JP A 11-181131, JP A 11-211901, JP A 11-211914, JP A 11-242119, JP A 11-246693, JP A 11-246694, JP A 11-256117, JP A 11-258425, JP A 11-263861, JP A 11-287902, JP A 11-295525, JP A 11-295527, JP A 11-302423, JP A 11-309830, JP A 11-323552, JP A 11-335641, JP A 11-344700, JP A 11-349947, JP A 11-95011, JP A 11-95030, JP A 11-95208, JP A 2000-109780, JP A 2000-110070, JP A 2000-119657, JP A 2000-141556, JP A 2000-147208, JP A 2000-17099, JP A 2000-171603, JP A 2000-171618, JP A 2000-180615, JP A 2000-187102, JP A 2000-187106, JP A 2000-191819, JP A 2000-191821, JP A 2000-193804, JP A 2000-204189, JP A 2000-206306, JP A 2000-214323, JP A 2000-214329, JP A 2000-230159, JP A 2000-235107, JP A 2000-241626, JP A 2000-250038, JP A 2000-267095, JP A 2000-284122, JP A 2000-292780, JP A 2000-292781, JP A 2000-304927, JP A 2000-304928, JP A 2000-304929, JP A 2000-309195, JP A 2000-309196, JP A 2000-309198, JP A 2000-309642, JP A 2000-310704, JP A 2000-310708, JP A 2000-310709, JP A 2000-310710, JP A 2000-310711, JP A 2000-310712, JP A 2000-310713, JP A 2000-310714, JP A 2000-310715, JP A 2000-310716, JP A 2000-310717, JP A 2000-321560, JP A 2000-321567, JP A 2000-329936, JP A 2000-329941, JP A 2000-338309, JP A 2000-338329, JP A 2000-344905, JP A 2000-347016, JP A 2000-347017, JP A 2000-347026, JP A 2000-347027, JP A 2000-347029, JP A 2000-347030, JP A 2000-347031, JP A 2000-347032, JP A 2000-347033, JP A 2000-347034, JP A 2000-347035, JP A 2000-347037, JP A 2000-347038, JP A 2000-86989, and JP A 2000-98392; and JP A 2001-4819, JP A 2001-4829, JP A 2001-4830, JP A 2001-4831, JP A 2001-4832, JP A 2001-4834, JP A 2001-4835, JP A 2001-4836, JP A 2001-4838, JP A 2001-4839, JP A 2001-100012, JP A 2001-108805, JP A 2001-108806, JP A 2001-133627, JP A 2001-133628, JP A 2001-142062, JP A 2001-142072, JP A 2001-174630, JP A 2001-174634, JP A 2001-174637, JP A 2001-179902, JP A 2001-183526, JP A 2001-183653, JP A 2001-188103, JP A 2001-188124, JP A 2001-188125, JP A 2001-188225, JP A 2001-188231, JP A 2001-194505, JP A 2001-228311, JP A 2001-228333, JP A 2001-242461, JP A 2001-242546, JP A 2001-247834, JP A 2001-26061, JP A 2001-264517, JP A 2001-272535, JP A 2001-278924, JP A 2001-2797, JP A 2001-287308, JP A 2001-305345, JP A 2001-311823, JP A 2001-311827, JP A 2001-350005, JP A 2001-356207, JP A 2001-356213, JP A 2001-42122, JP A 2001-42323, JP A 2001-42325, JP A 2001-51118, JP A 2001-51119, JP A 2001-51120, JP A 2001-51273, JP A 2001-51274, JP A 2001-55573, JP A 2001-66431, JP A 2001-66597, JP A 2001-74920, JP A 2001-81469, JP A 2001-83329, JP A 2001-83515, JP A 2001-91719, JP A 2002-162628, JP A 2002-169024, JP A 2002-189421, JP A 2002-201367, JP A 2002-20410, JP A 2002-258046, JP A 2002-275391, JP A 2002-294174, JP A 2002-311214, JP A 2002-311246, JP A 2002-328233, JP A 2002-338703, JP A 2002-363266, JP A 2002-365164, JP A 2002-370303, JP A 2002-40209, JP A 2002-48917, JP A 2002-6109, JP A 2002-71950, JP A 2002-82222, JP A 2002-90528, JP A 2003-105540, JP A 2003-114331, JP A 2003-131036, JP A 2003-139952, JP A 2003-153353, JP A 2003-172819, JP A 2003-35819, JP A 2003-43252, JP A 2003-50318, and JP A 2003-96066.

Various substances for dopes are specifically described next.

For a raw material of the dope, cellulose ester can be preferably used for obtaining high transparency. Examples of cellulose esters are cellulose triacetate, cellulose acetate propionate, cellulose acetate butylate and other cellulose esters of lower fatty acid. In particular, cellulose acetate is preferable. Specifically, triacetyl cellulose (TAC) is desirable. Note that the dope in the present embodiment contains triaqetyl cellulose (TAC) as polymer. Preferably, 90 wt. % or more of the entirety of TAC should be particles of 0.1-4 mm. Polymer content in the dope is not limited to cellulose ester, but can be any of known examples that is soluble in a solvent to obtain the dope.

Preferable examples of cellulose acylates satisfy all of the conditions I-III as follows for the purpose of high transparency:
2.5≦A+B≦3.0 I
0≦A≦3.0 II
0≦B≦2.9 III

where A and B represent a degree of substitution of an acyl group (—CO—R) formed by substituting hydroxy groups in cellulose. A represents a degree of substitution of an acetyl group (—CO—CH₃) formed by substituting hydroxy groups in cellulose. B represents a total degree of substitution of acyl groups having 3-22 carbon atoms.

The cellulose is constructed by glucose units making a beta-1,4 bond, and each glucose unit has a liberated hydroxy group at second, third and sixth positions. Cellulose acylate is a polymer in which part or whole of the hydroxy groups are esterified so that the hydrogen is substituted by acyl groups having two or more carbon atoms. The degree of substitution for the acyl groups in cellulose acylate is a degree of esterification at second, third or sixth position in cellulose. Accordingly, when 100% of the hydroxy group at the same position is substituted, the degree of substitution at this position is 1.

The total degree of substitution DS2+DS3+DS6 for the acyl groups at the second, third or sixth positions is in the range of 2.00-3.00, preferably 2.22-2.90, and in particular preferably 2.40-2.88. The sign DS2 is a degree of substitution for the acyl groups at the second position in hydroxy groups in the glucose unit. The signs DS3 and DS6 are degrees of substitution for the acyl groups at respectively the third and sixth positions in hydroxy groups in the glucose unit. Further, a ratio DS6/(PS2+DS3+DS6) is preferably 0.28 or more, and particularly 0.30, or more, and especially in the range of 0.31-0.34.

An acyl group of only one example may be contained in the cellulose acylate of the invention. However, cellulose acylate may contain acyl groups of two or more examples. If two or more acyl groups are contained, one of the plural acyl groups should be preferably an acetyl group. Let DSA be a total degree of substitution for the acetyl groups. Let DSB be a total degree of substitution for other acyl groups at the second, third or sixth positions than the acetyl groups. The value DSA+DSB is preferably in the range of 2.22-2.90, and particularly in the range of 2.40-2.88.

Further, the DSB is preferably at least 0.30, and especially at least 0.70. Furthermore, in the DSB, the percentage of a substituent at the sixth position is preferably at least 20%, preferably at least 25%, especially at least 30% and most especially at least 33%. Further, the value DSA+DSB at the sixth position is at least 0.75, preferably at least 0.80, and especially 0.85. Cellulose acylate satisfying the above conditions can be used to prepare a solution or dope having a preferable solubility. Especially, when chlorine-free type organic solvent is used, the adequate dope can be prepared. Also, the dope can be prepared to have a low viscosity, high solubility, and the suitability for filtration becomes higher.

Cellulose to produce cellulose acylates can be obtained any one of linter cotton and pulp cotton, but preferably can be obtained from linter cotton.

Examples of acyl groups in cellulose acylates having two or more carbon atoms can be aliphatic groups, aryl groups, and the like. For example, cellulose acylates may be alkyl carbonyl esters, alkenyl carbonyl esters, aromatic carbonyl esters, aromatic alkyl carbonyl esters, and the like of cellulose, and can further contain a substitution group. Preferable examples of groups include: propionyl, butanoyl, pentanoyl, hexanoyl, octanoyl, decanoyl, dodecanoyl, tridecanoyl, tetradecanoyl, hexadecanoyl, octadecanoyl, iso-butanoyl, tert-butanoyl, cyclohexane carbonyl, oleoyl, benzoyl, naphthyl carbonyl, and cinnamoyl. Among those, particularly preferable groups are propionyl, butanoyl, dodecanoyl, octadecanoyl, tert-butanoyl, oleoyl, benzoyl, naphthyl carbonyl, and cinnamoyl. Further, specifically preferable groups are propionyl and butanoyl.

Details of cellulose acylates are according to various relevant techniques suggested in JP-A 2005-104148. Those examples and their various features can be used in the present invention.

I. Specific Examples of Cellulose Acylates

Suggested in JP A 57-182737 (corresponding to U.S. Pat. No. 4,499,043), JP A 10-45803 (corresponding to U.S. Pat. No. 5,856,468), JP A 11-269304 (corresponding to U.S. Pat. No. 6,139,785), JP A 8-231761, JP A 10-60170, JP A 9-40792, JP A 11-5851, JP A 9-90101, JP A 4-277530, JP A 11-292989, JP A 2000-131524, and JP A 2000-137115.

II. Specific Examples of Solvents for Esters and their Dissolution

Suggested in JP A 10-324774, JP A 8-152514, JP A 10-330538, JP A 9-95538 (corresponding to U.S. Pat. No. 5,663,310), JP A 9-95557 (corresponding to U.S. Pat. No. 5,705,632), JP A 10-235664 (corresponding to U.S. Pat. No. 6,036,913), JP A 2000-63534, JP A 11-21379, JP A 10-182853, JP A 10-278056, JP A 10-279702, JP A 10-323853 (corresponding to U.S. Pat. No. 6,036,913), JP A 10-237186, JP A 11-60807, JP A 11-152342, JP A 11-292988, JP A 11-60752, JP A 2000-95876, and JP A 2000-95877.

Solvent as raw material of dope is preferably an organic compound in which polymer is soluble. The term of dope in the invention is used as mixture obtained by dissolution or dispersion of polymer in a solvent. It is possible to use a solvent with low solubility for polymer. Examples of solvents for preparing the dope include:

aromatic hydrocarbons, such as benzene and toluene;

halogenated hydrocarbons, such as dichloromethane, chloroform and chlorobenzene;

alcohols, such asmethanol, ethanol, n-propanol, n-butanol, and diethylene glycol;

ketones, such as acetone and methyl ethyl ketone;

esters, such as methyl acetate, ethyl acetate, and propyl acetate;

ethers, such as tetrahydrofuran and methyl cellosolve.

It is possible selectively to use two or more of those by mixture. In particular, dichloromethane can be used to obtain dope with high solubility. The solvent in the cast film can be evaporate to form the polymer film.

Preferable halogenated hydrocarbons for use contain 1-7 carbon atoms. Specifically, it is preferable in a mixed solvent to mix one or more alcohols containing 1-5 carbon atoms with the dichloromethane, for the purpose of high solubility, easy separability from a support for casting, mechanical strength of film material, and various optical characteristics of a cellulose ester. Such alcohols are contained in the mixed solvent preferably in a range of 2-25 wt. %, and desirably in a range of 5-20 wt. %. Preferable examples of alcohols are methanol, ethanol, n-propanol, isopropanol, n-butanol and the like. Among those, specifically preferable alcohols are methanol, ethanol, n-butanol, and mixture of two or more of them.

Solvents not containing dichloromethane are effectively used in the publicly suggested requirement, for the purpose of minimizing influence to environment. Examples of compounds useful to this end are ethers having 4-12 carbon atoms, ketones having 3-12 carbon atoms, and esters having 3-12 carbon atoms. Ethers, ketones, esters and alcohols of the examples may have a cyclic structure. Compounds having two or more functional groups of —O—, —CO— and —COO—, namely groups of ethers, ketones and esters can be used as a solvent. A compound as solvent may have other functional groups, such as alcoholic hydroxy group. If two or more functional groups are included, the number of carbon atoms can satisfy a range condition of a compound having any one of the two functional groups. The number of carbon atoms is not limited.

Various additives may be mixed in the dope for purposes, such as plasticizers, ultraviolet (UV) absorbers, deterioration inhibitors, lubricants, stripping accelerators, and other additives. Preferable examples of plasticizers are triphenyl phosphate, biphenyl diphenyl phosphate, and other phosphate esters, and diethyl phthalate and other phthalate esters, and polyester polyurethane elastomer.

Fine particles can be preferably added to dope for the purpose of preventing adhesion between polymer films, and adjusting a refractive index. Examples of materials of the fine particles are silicon dioxide derivatives. Examples of silicon dioxide derivatives include silicon dioxide, silicone resin in a honeycomb structure of three dimensions, and the like. Preferably, the surface of the silicon dioxide derivative is an alkylated surface. Fine particles processed by alkylation or hydrophobic modification have high dispersibility in solvent. Dope can be prepared without agglomeration of fine particles, to produce polymer film reliably. The polymer film can have high transparency with a reduced amount of surface defects.

An example of fine particles with an alkylated surface is Aerosil R805 (trade name) manufactured by Nippon Aerosil Co., Ltd., as a derivative of silicon dioxide with an octyl group on the surface. The ratio of the content of the fine particles relative to the solid content of the dope is preferably 0.2% or less for the purpose of obtaining polymer film with high transparency and with effects of adding the fine particles. An average particle diameter of the fine particles, in view of allowing passage of light without blocking, is equal to or less than 1.0 micron, preferably 0.3-1.0 micron, and desirably 0.4-0.8 micron.

For a raw material of the dope, triacetyl cellulose (TAC) as polymer be preferably used for obtaining high transparency of polymer film. According to the above embodiment, a dope containing TAC at a density of 5-40 wt. % is obtained. A density of the TAC in the dope is preferably equal to or more than 15 wt. % and equal to or less than 30 wt. %, and desirably equal to or more than 17 wt. % and equal to or less than 25 wt. %. A density of the additive, of which a main content is a plasticizer, in the dope is preferably equal to or more than 1 wt. % and equal to or less than 20 wt. % in 100 wt. % of the solid content in the dope.

Uses of various materials in relation to the polymer have been suggested in JP-A 2005-104148, including solvents, plasticizers, deterioration inhibitors, ultraviolet (UV) absorbers, lubricants, stripping accelerators, optical anisotropy control agents, retardation control agents, dyes, release agents, and other additives.

I. Plasticizers

Suggested in JP A 4-227941, JP A 5-194788, JP A 60-250053, JP A 6-16869, JP A 5-271471, JP A 7-286068, JP A 5-5047 (corresponding to U.S. Pat. No. 5,279,659), JP A 11-80381, JP A 7-20317, JP A 8-57879, JP A 10-152568, and JP A 10-120824.

II. Deterioration Inhibitors and UV Absorbers

Suggested in JP A 60-235852, JP A 3-199201, JP A 5-190707, JP A 5-194789, JP A 5-197073, JP A 5-271471, JP A 6-107854, JP A 6-118233, JP A 6-148430, JP A 7-11055, JP A 7-11056, JP A 8-29619, JP A 8-239509 (corresponding to U.S. Pat. No. 5,806,834), JP A 2000-204173, and JP A 2000-193821.

In the dope production from cellulose triacetate, various techniques suggested in JP-A 2005-104148 for dissolution of materials and additives, filtration, elimination of bubbles, mixing of additives can be used.

No. 1. Dissolution Related to Casting

Suggested in JP A 9-95544 (corresponding to U.S. Pat. No. 5,663,310), JP A 10-45950, JP A 10-95854 (corresponding to U.S. Pat. No. 5,783,121), and JP A 2000-53784.

No. 2. Specific Preparing Methods of Solutions

Suggested in JP A 11-310640 (corresponding to U.S. Pat. No. 6,211,358), JP A 11-323017, JP A 11-302388, and JP A 2000-273184. No. 3. Condensation of solutions

Suggested in JP A 4-259511; U.S. Pat. No. 2,541,012, U.S. Pat. No. 2,858,229, U.S. Pat. No. 4,414,341, and U.S. Pat. No. 4,504,355.

Examples and comparisons, which were produced in connection with the present invention, are hereinafter described for explanation of the invention. Note that the invention is not limited to the examples and comparisons

### Example 1

In FIG. 1, the polymer film 18 was produced by the polymer film producing apparatus 10. The dope producing device 30 supplied the casting die 33 with dope of a suitable amount through the feed block 31. In FIG. 2, the slot of the casting die 33 ejected the dope on to the support drum 34 rotating continuously. A flow rate of the dope was so conditioned as to form the polymer film 18 being 80 microns thick after drying. Also, the rear side of the bead was decompressed by conditioning the pressure of the decompression chamber 45 at 600 Pa. Dichloromethane as layer forming liquid was cast by the intermediate layer forming device 71 on to the support drum 34. A flow rate of the intermediate layer forming device 71 was so conditioned as to form the intermediate layer 72 being 3 microns thick after drying.

The support drum 34 was a drum of stainless steel, and controllable by a driving device (not shown) for rotational speed. Heat exchange medium or coolant was supplied by a heat exchange medium circulator (not shown) to the support drum 34, which was conditioned at the surface temperature of −10 deg. C. Voltage was applied by the voltage application device 36 as charge applicator to the support drum 34 before casting the dope, to set the surface potential V at 2 kV. In the casting chamber 14, a flow of nitrogen gas was controlled to set the oxygen density lower than 10 wt. %. The casting chamber 14 was conditioned by the temperature adjuster 43 with the inner temperature of 35 deg. C. The casting die 33 had a slot with a width of 1.8 meters. A jacket (not shown) was provided in combination with the casting die 33, for maintaining the heat exchange medium at the temperature 36 deg. C. at an upstream end of the jacket, for setting the dope at 36 deg. C. Conduits for dope and the feed block 31 were conditioned by heat adjusters equally at the inner temperature of 36 deg. C.

The cast film 12 gelled to have the self-supporting property was supported by the stripping roller 38 and stripped from the support drum 34 with the intermediate layer 72. The cast film 12 was transported to the transition region 16, where the fan or blower 54 blew dry air conditioned at 40 deg. C. to the cast film 12 to dry the cast film 12 in transport by plural transport rollers. Then the cast film 12 was sent to the tentering machine 19 of a pin type. A plurality of pins were pierced in web edge portions of the cast film 12. Dry air was blown by a dryer (not shown) to the cast film 12 while the cast film 12 was stretched in the web width direction. The cast film 12 was dried to obtain the polymer film 18.

Web edges of the polymer film 18 were slitted by the web edge slitter 20 within 30 seconds after moving from a downstream end of the tentering machine 19. An NT cutter in the web edge slitter 20 slitted the web edges on lines extending at a distance of 50 mm from the edge lines. A cutter blower (not shown) moved the obtained web edge portions by blowing into the film crusher 56, which ground the web edge portions into chips or particles with an average area of 80 sq. mm.

Between the web edge slitter 20 and the drying chamber 22, there was a pre-drying chamber (not shown), which heated the polymer film 18 in a preliminary manner with dry gas of 100 deg. C. before drying in the drying chamber 22. A temperature adjuster (not shown) conditioned the inner temperature of the drying chamber 22 to keep the surface temperature of the polymer film 18 at 140 deg. C. The polymer film 18 was transported through the drying chamber 22 by the rollers 58, and dried by the drying chamber 22. Time of drying the polymer film 18 with the drying chamber 22 was 10 minutes. The surface temperature of the polymer film 18 was measured by a thermometer (not shown) disposed close to the surface of the polymer film 18 and directly higher than the path of the polymer film 18. The solvent gas contained in the dry gas was collectively removed by adsorption of the adsorption solvent recovery device 59. An agent for adsorption was activated carbon. Desorption after the absorption was made by use of dry nitrogen. The collected solvent was conditioned with water at a small level of 0.3 wt. % of water content, so the water content of the solvent gas was eliminated.

A fluidity adjusting chamber (not shown) was installed between the drying chamber 22 and the cooling chamber 23. At first, air at the temperature of 50 deg. C. and having the condensation point of 20 deg. C. was blown by the fluidity adjusting chamber to the polymer film 18. Then air at the temperature of 90 deg. C. and having humidity of 70% RH was blown by the fluidity adjusting chamber to the polymer film 18, so that curl in the polymer film 18 was eliminated. Then the polymer film 18 was transported into the cooling chamber 23, and was gradually cooled to a level equal to or lower than 30 deg. C. The voltage of electrification of the polymer film 18 was conditioned by the static eliminator 25 in a range equal to or higher than −3 kV and equal to or lower than +3 kV. While the polymer film 18 was transported, the knurling roller 26 knurled each of the web edge portions of the polymer film 18, and straightened unevenness of its surface. The knurling was edge embossing at a width of 10 mm. A pressure for knurling was conditioned so as to obtain an average maximum height of the knurled pattern being 12 microns higher than an average thickness of the polymer film 18.

The polymer film 18 was transported into the winder 28, where the press roller 61 pressed the polymer film 18 at the pressure of 50 N/m and the polymer film 18 was wound by the winding roller 62 having a diameter of 169 mm. The tension to the polymer film 18 was 300 N/m at the start of winding, and was 200 N/m at the end of winding. Thus, a roll of the polymer film 18 was obtained. The polymer film 18 was 80 microns thick. In the entirety of the film production, an average drying speed of the cast film 12 or the Polymer film 18 was 20 wt. % per minute.

Raw materials for the dope in the example were as follows.

[Materials for Dope]

| | | |
|---|---|---|
| Cellulose triacetate | 100 | parts by weight |
| Dichloromethane | 320 | parts by weight |
| Methanol | 83 | parts by weight |
| 1-butanol | 3 | parts by weight |
| Plasticizer A | 7.6 | parts by weight |
| Plasticizer B | 3.8 | parts by weight |
| UV absorber a | 0.7 | part by weight |
| UV absorber b | 0.3 | part by weight |
| Mixture of citrate esters | 0.006 | part by weight |
| Fine particles | 0.05 | part by weight |

In the list, the cellulose triacetate was powder particles having the following specifics—substitution degree: 2.84, viscosity average degree of polymerization (DP): 306, water content: 0.2 wt. %, viscosity of 6 wt. % dichloromethane solution: 315 mPa·s, average particle diameter of powder particles: 1.5 mm, standard deviation of the particle diameter of powder particles: 0.5 mm. The plasticizer A was triphenylphosphate. The plasticizer B was diphenylphosphate. The UV absorber a was 2(2′-hydroxy-3′,5′-di-tert-butylphenyl) benzotriazol. The UV absorber b was 2(2′-hydroxy-3′,5′-di-tert-amylphenyl) 5-chlorobenzotriazol. The citrate ester compound was mixture of citrate esters (mixture of citric acid, citrate monoethyl ester, citrate diethyl ester, and citrate triethyl ester). The fine particles were particles of silicon dioxide with a particle diameter of 15 nm, and Mohs hardness number of approx. 7. In the preparation of the dope, retardation control agent N—N-di-m-toluoyl-N-p-methoxy phenyl-1,3,5-triazine-2,4,6-triamine was added at an amount of 4.0 wt. % relative to the total weight of the polymer film.

To evaluate the effect of the invention, entrainment of air on the bead was observed by human eyes. As a result, no air was initially found entrained in the bead of the dope. Air was found entrained in the bead of the dope at first when the casting speed of the dope came up to 120 meters per minute. The following Examples and comparisons were also observed in the same evaluation.

### Example 2

Example 1 was repeated to produce the polymer film 18 with a difference of the surface potential of the support drum 34 set at 0.7 kV. As a result, air was found entrained in the bead of the dope at first when the casting speed of the dope came up to 110 meters per minute.

### Example 3

Example 1 was repeated to produce the polymer film 18 with a difference in that the surface potential of the support drum 34 was set at 0.7 kV, and that no intermediate layer 72 was formed. As a result, air was found entrained in the bead of the dope at first when the casting speed of the dope came up to 100 meters per minute.

### Example 4

Example 1 was repeated with a difference in that the decompression chamber 45 was not used. As a result, air was found entrained in the bead of the dope when the casting speed of the dope was 100 meters per minute.

### Comparison 1

Example 1 was repeated with a difference in that the surface of the support drum 34 was not electrified. As a result, air was found entrained in the bead of the dope although the casting speed of the dope was 90 meters per minute.

### Comparison 2

Example 1 was repeated with a difference in that the surface of the support drum 34 was not electrified, and that the decompression chamber 45 was not used. As a result, air was found entrained in the bead of the dope although the casting speed of the dope was 80 meters per minute.

In conclusion, it is observed that the casting speed of dope can be raised to 110-120 meters per minute without entrainment of air. This is in contrast with the casting speed of 90 meters per minute or so according to the known techniques. Speed of the solution casting can be higher to form a cast film with high flatness without holes or bubbles. Polymer film with high quality can be produced stably and rapidly.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A polymer film producing method comprising:
a casting step of ejecting dope from a casting die, and casting bead of said dope on a support traveling continuously to form a cast film, said dope containing polymer, solvent and additive;
a drying step of drying said cast film stripped from said support, to obtain a polymer film;
wherein during said casting step, voltage is applied to said support by a voltage application device connected with said support.

2. A polymer film producing method as defined in claim 1, wherein said support is electrically non-grounded, and has a surface coated with an electrical insulation film.

3. A polymer film producing method as defined in claim 2, wherein said electrical insulation film is formed from a material selected from ceramic material and plastic material, and said material contains at least a selected one of alumina, zirconia, chromium oxide, and titania.

4. A polymer film producing method as defined in claim 2, wherein a surface potential V of said support is in a range of 0.1 kV<|V|<3 kV.

5. A polymer film producing method as defined in claim 4, wherein in said casting step, said dope is cast in a condition of an oxygen density lower than 10 wt. %.

6. A polymer film producing method as defined in claim 1, wherein a tightening device is disposed close to a surface of said support, for tightening contact of said bead on said surface of said support.

7. A polymer film producing method as defined in claim 6, wherein said tightening device is a decompression device, disposed close to a slot of said casting die, for decompressing a space upstream from said bead with respect to traveling of said support.

8. A polymer film producing method as defined in claim 7, wherein said decompression device sets said space upstream from said bead at a pressure equal to or more than (AP—2,000 Pa) and equal to or less than (AP—10 Pa), where AP is an atmospheric pressure.

9. A polymer film producing method as defined in claim 6, wherein said tightening device is an intermediate layer forming device, disposed upstream from said casting die with respect to traveling of said support, for delivery of liquid between said support and said cast film, to form an intermediate layer, said liquid containing at least one solvent contained in said dope.

10. A polymer film producing method as defined in claim 2, wherein said electrical insulation film has a multi-layer structure.

11. A polymer film producing apparatus comprising:
a casting device, having a casting die, for ejecting dope, and casting bead of said dope on a support traveling continuously to form a cast film, said dope containing polymer, solvent and additive;
a dryer for drying said cast film stripped from said support, to obtain a polymer film; and
a voltage application device, connected with said support, for applying voltage to said support during casting of said casting device.

12. A polymer film producing apparatus as defined in claim 11, wherein said support is electrically non-grounded, and has a surface coated with an electrical insulation film.

13. A polymer film producing apparatus as defined in claim 12, wherein said electrical insulation film is formed from a material selected from ceramic material and plastic material, and said material contains at least a selected one of alumina, zirconia, chromium oxide, and titania.

14. A polymer film producing apparatus as defined in claim 12, wherein said voltage application device sets a surface potential V of said support in a range of 0.1 kV<|V|<3 kV.

15. A polymer film producing apparatus as defined in claim 14, wherein said casting device casts said dope in a condition of an oxygen density lower than 10 wt. %.

16. A polymer film producing apparatus as defined in claim 11, further comprising a tightening device, disposed close to a surface of said support, for tightening contact of said bead on said surface of said support.

17. A polymer film producing apparatus as defined in claim 16, wherein said tightening device is a decompression device, disposed close to a slot of said casting die, for decompressing a space upstream from said bead with respect to traveling of said support.

18. A polymer film producing apparatus as defined in claim 17, wherein said decompression device sets said space upstream from said bead at a pressure equal to or more than (AP—2,000 Pa) and equal to or less than (AP—10 Pa), where AP is an atmospheric pressure.

19. A polymer film producing apparatus as defined in claim 16, wherein said tightening device is an intermediate layer forming device, disposed upstream from said casting die with respect to traveling of said support, for delivery of liquid between said support and said cast film, to form an intermediate layer, said liquid containing at least one solvent contained in said dope.
